(19) United States
(12) Patent Application Publication
(10) Pub. No.: US 2013/0040528 A1
(43) Pub. Date: Feb. 14, 2013

(54) IRRADIATING APPARATUS AND IRRADIATING METHOD FOR LIQUID CRYSTAL PANEL

(71) Applicants: Kuan-cheng Lee, Shenzhen (CN); Chunliang Lee, Shenzhen (CN)

(72) Inventors: Kuan-cheng Lee, Shenzhen (CN); Chunliang Lee, Shenzhen (CN)

(73) Assignee: Shenzhen China Star Optoelectronics Technology Co. Ltd., Shenzhen, Guangdong (CN)

(21) Appl. No.: 13/380,048

(22) PCT Filed: Oct. 19, 2011
(86) PCT No.: PCT/CN11/80971

§ 371 Date: Dec. 22, 2011

(30) Foreign Application Priority Data
Aug. 10, 2011 (CN) 201110228835.9
Oct. 19, 2011 (CN) PCT/CN2011/080971

(51) Int. Cl. H01J 9/26

(52) U.S. Cl. 445/25; 445/66

(57) ABSTRACT

An irradiating apparatus and an irradiating method for a liquid crystal panel are provided in the present disclosure. The irradiating apparatus for the liquid crystal panel comprises an ultraviolet (UV) light emitter and a wavelength filter. The wavelength filter is disposed in front of the UV light emitter and adapted to allow UV light having wavelengths of 300-400 nm emitted by the UV light emitter to pass therethrough. By setting wavelengths of the UV light of 300-400 nm, the irradiating apparatus and the method for the liquid crystal panel of the present disclosure can reduce the time of irradiating the sealant for sealing the liquid crystal panel with UV light during the process of curing the sealant. Thereby, the production efficiency is improved.

### BACKGROUND

1. Technical Field

The present disclosure relates to the technical field of liquid crystal panel production facilities, and more particularly, to an irradiating apparatus and an irradiating method for a liquid crystal panel.

2. Description of Related Art

Currently, during the manufacturing process of a liquid crystal panel, ultraviolet (UV) light is usually used to irradiate and activate curing factors incorporated in sealant for sealing the liquid crystal panel so as to cure the sealant. Conventionally, it is difficult to restrict the wavelength of the UV light within a desirable range during the process of irradiating the sealant for sealing the liquid crystal panel by the UV light, so the irradiation process often must be carried out until the sealant cures. Therefore, the time of UV light irradiation is too long, which leads to poor production efficiency.

### BRIEF SUMMARY

The primary objective of the present disclosure is to provide an irradiating apparatus and an irradiating method for a liquid crystal panel, which can reduce the time of irradiating the liquid crystal panel with UV light during the process of manufacturing the liquid crystal panel so as to improve the production efficiency.

To achieve the aforesaid objective, the present disclosure adopts the following technical solutions.

The present disclosure provides an irradiating apparatus for the liquid crystal panel, comprising:

an ultraviolet (UV) light emitter, being adapted to emit UV light for irradiating a sealant used to seal the liquid crystal panel; and

a wavelength filter disposed in front of the UV light emitter, being adapted to allow UV light having wavelengths of 300-400 nm emitted by the UV light emitter to pass therethrough.

Preferably, an area of an irradiation region of the UV light emitter is smaller than or equal to a surface area of the wavelength filter that faces towards the UV light emitter directly.

Preferably, the UV light emitter comprises at least one UV light emission lamp and a carrier for disposing the at least one UV light emission lamp thereon.

The present disclosure further provides an irradiating method for the liquid crystal panel, comprising the following steps of:

disposing a wavelength filter in front of a UV light emitter;

controlling the UV light emitter to emit UV light; and

controlling the wavelength filter in such a way that wavelengths of UV light passing through the wavelength filter to a sealant used to seal the liquid crystal panel range from 300nm to 400 nm.

Preferably, an area of an irradiation region of the UV light emitter is smaller than or equal to a surface area of the wavelength filter that faces towards the UV light emitter directly.

Preferably, the UV light emitter comprises at least one UV light emission lamp and a carrier for disposing the at least one UV light emission lamp thereon.

The technical solutions of the present disclosure have the following benefits: by setting wavelengths of the UV light of 300-400 nm, the irradiating apparatus and method for the liquid crystal panel according to the present disclosure can reduce the time of irradiating the sealant for sealing the liquid crystal panel with UV light during the process of curing the sealant. Thereby, the production efficiency is improved.

### BRIEF DESCRIPTION OF THE DRAWINGS

FIG. 1 is a schematic structural view of a preferred embodiment of an irradiating apparatus for a liquid crystal panel according to the present disclosure; and

FIG. 2 is a flowchart diagram of a preferred embodiment of an irradiating method for a liquid crystal panel according to the present disclosure.

### DETAILED DESCRIPTION

To make the objectives, technical solutions and advantages of the present disclosure clearer, the present disclosure will be further described herein with reference to the attached drawings and embodiments thereof. However, it shall be understood that, the embodiments described herein are only intended to illustrate but not to limit the present disclosure.

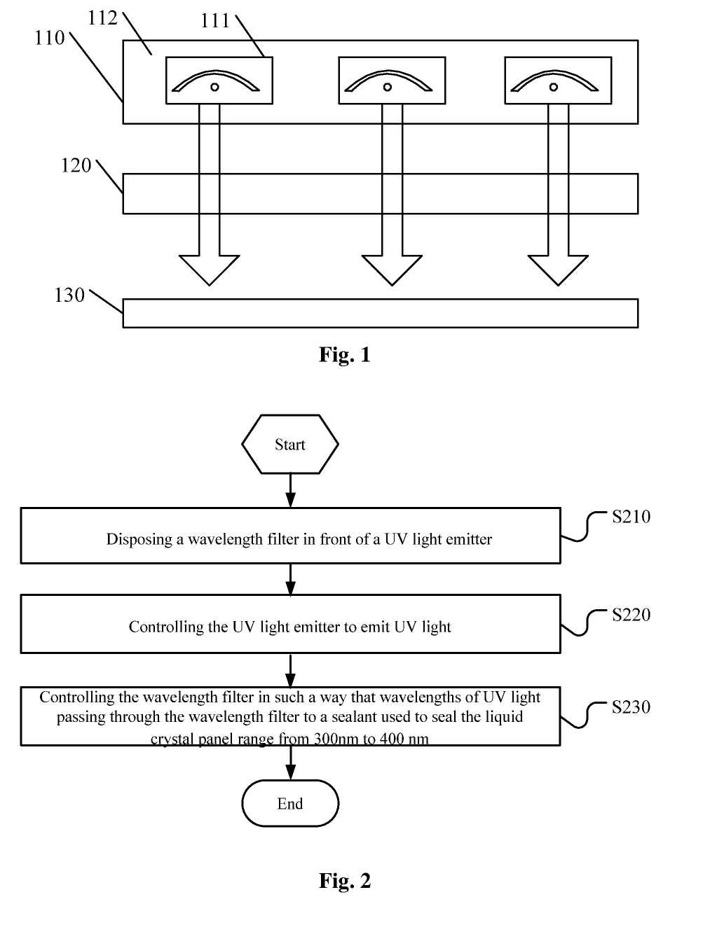

Referring to FIG. 1, an embodiment of the present disclosure provides an irradiating apparatus for a liquid crystal panel. FIG. 1 is a schematic structural view of a preferred embodiment of the irradiating apparatus for a liquid crystal panel according to the present disclosure.

The irradiating apparatus comprises: an ultraviolet (UV) light emitter 110 and a wavelength filter 120. The wavelength filter 120 is disposed in front of the UV light emitter 110.

The UV light emitter 110 is adapted to emit UV light for irradiating a sealant used to seal the liquid crystal panel. In this embodiment, the UV light emitter 110 comprises at least one UV light emission lamp 111 and a carrier 112 for disposing the at least one UV light emission lamp 111 thereon. The number of the at least one UV light emission lamp 111 may be determined depending on actual requirements.

The wavelength filter 120 is adapted to filter the UV light emitted by the UV light emitter 110 and only allows UV light having wavelengths of 300-400 nm to pass therethrough. The UV light having wavelengths of 300-400 nm are irradiated onto a liquid crystal panel 130 to activate the curing factors incorporated in a sealant for sealing the liquid crystal panel 130. The curing factors for initiating curing of the sealant can optimally absorb UV light having wavelengths of 300-400 nm so as to cure the sealant fully and quickly. Therefore, the irradiating apparatus for the liquid crystal panel of this embodiment can reduce the time of irradiating the sealant for sealing the liquid crystal panel with UV light during the process of curing the sealant. Thereby, the production efficiency is improved.

Preferably in the aforesaid embodiment, an area of an irradiation region of the UV light emitter 110 is smaller than or equal to a surface area of the wavelength filter 120 that faces towards the UV light emitter 110 directly so as to guarantee that UV light received by the liquid crystal panel 130 passes through the wavelength filter 120.

An embodiment of the present disclosure further provides an irradiating method for a liquid crystal panel, which adopts the same hardware used in the aforesaid irradiating apparatus for the liquid crystal panel. Referring to FIG. 2, there is shown a flowchart diagram of a preferred embodiment of an irradiating method for the liquid crystal panel according to the present disclosure. The irradiating method comprises the following steps of:

S210: disposing a wavelength filter in front of a UV light emitter;

S220: controlling the UV light emitter to emit UV light; and

S230: controlling the wavelength filter in such a way that wavelengths of UV light passing through the wavelength filter to a sealant for sealing the liquid crystal panel range from 300 nm to 400 nm.

In the aforesaid embodiment, an area of an irradiation region of the UV light emitter is smaller than or equal to a surface area of the wavelength filter that faces towards the UV light emitter 110 directly so as to guarantee that all UV light received by a liquid crystal panel passes through the wavelength filter.

Preferably, the UV light emitter comprises at least one UV light emission lamp and a carrier for disposing the at least one UV light emission lamp thereon.

The irradiating method for the liquid crystal panel of this embodiment can reduce the time of irradiating the sealant for sealing the liquid crystal panel with UV light during the process of curing the sealant. Thereby, the production efficiency is improved.

What described above are only preferred embodiments of the present disclosure but are not intended to limit the scope of the present disclosure. Accordingly, any equivalent structural or process flow modifications that are made on basis of the specification and the attached drawings or any direct or indirect applications in other technical fields shall also fall within the scope of the present disclosure.

What is claimed is:

1. An irradiating apparatus for a liquid crystal panel, comprising:
an ultraviolet (UV) light emitter, being adapted to emit UV light for irradiating a sealant used to seal the liquid crystal panel; and
a wavelength filter disposed in front of the UV light emitter, being adapted to allow UV light having wavelengths of 300-400 nm emitted by the UV light emitter to pass therethrough.

2. The irradiating apparatus for the liquid crystal panel of claim 1, wherein an area of an irradiation region of the UV light emitter is smaller than or equal to a surface area of the wavelength filter that faces towards the UV light emitter directly.

3. The irradiating apparatus for the liquid crystal panel of claim 2, wherein the UV light emitter comprises at least one UV light emission lamp and a carrier for disposing the at least one UV light emission lamp thereon.

4. An irradiating apparatus for a liquid crystal panel, comprising:
a UV light emitter, being adapted to emit UV light for irradiating a sealant used to seal the liquid crystal panel; and
a wavelength filter disposed in front of the UV light emitter, being adapted to allow UV light having wavelengths of 300-400 nm emitted by the UV light emitter to pass therethrough,
wherein an area of an irradiation region of the UV light emitter is smaller than or equal to a surface area of the wavelength filter that faces towards the UV light emitter directly.

5. The irradiating apparatus for the liquid crystal panel of claim 4, wherein the UV light emitter comprises at least one UV light emission lamp and a carrier for disposing the at least one UV light emission lamp thereon.

6. An irradiating method for a liquid crystal panel, comprising the following steps of:
disposing a wavelength filter in front of a UV light emitter;
controlling the UV light emitter to emit UV light; and
controlling the wavelength filter in such a way that wavelengths of UV light passing through the wavelength filter to a sealant used to seal the liquid crystal panel range from 300 nm to 400 nm.

7. The irradiating method of claim 6, wherein an area of an irradiation region of the UV light emitter is smaller than or equal to a surface area of the wavelength filter that faces towards the UV light emitter directly.

8. The irradiating method of claim 7, wherein the UV light emitter comprises at least one UV light emission lamp and a carrier for disposing the at least one UV light emission lamp thereon.
